(19) United States
(12) Patent Application Publication
(10) Pub. No.: US 2017/0060863 A1
(43) Pub. Date: Mar. 2, 2017

(54) SYSTEM, METHOD, AND APPARATUS FOR A COLOR SEARCH

(71) Applicant: ALIBABA GROUP HOLDING LIMITED, Grand Cayman (KY)

(72) Inventor: Miao Zhang, Beijing (CN)

(73) Assignee: ALIBABA GROUP HOLDING LIMITED

(21) Appl. No.: 15/247,743

(22) Filed: Aug. 25, 2016

(30) Foreign Application Priority Data
Aug. 25, 2015 (CN) 201510526456.6

(51) Int. Cl. G06F 17/30

(52) U.S. Cl. CPC G06F 17/3025; G06F 17/30867; G06F 17/30398

(57) ABSTRACT

A method for a color search is disclosed. The method may be implemented by a user device terminal. The method may comprise sending a color search request and corresponding color encoding information to a network device, and receiving search result information that matches the color encoding information and that is returned by the network device based on the color search request.

### CROSS REFERENCE TO RELATED APPLICATION

The present application is based on and claims the benefits of priority to Chinese Application No. 201510526456.6, filed Aug. 25, 2015, the entire contents of which are incorporated herein by reference.

### TECHNICAL FIELD

The present application relates to methods, apparatus, and systems for a color search.

### BACKGROUND

Using current technologies, a user can input or select color name information, e.g., red or blue, as a search condition, so that a matching search result corresponding to the entered color name information may be provided for the user. However, only well-known colors have defined color name information (e.g., “red” or “blue”), while most other colors do not. Also, since a color may be subjective to different people, different providers may provide different color name information for the same color or provide the same color name information for different colors. Likewise, color name information submitted by a user requesting a search may also be subjective. Therefore, the searching and matching process based on textual color name information alone cannot guarantee accurate results, and the search results are less than desirable.

### SUMMARY

One aspect of the present disclosure is directed to a method for a color search. The method may be implemented by a user device terminal. The method may comprise sending a color search request and corresponding color encoding information to a network device, and receiving search result information that matches the color encoding information and that is returned by the network device based on the color search request.

Another aspect of the present disclosure is directed to a method for a color search. The method may be implemented by a network device. The method may comprise acquiring, from a user terminal device, a color search request and the corresponding color encoding information, querying according to the acquired color encoding information to obtain search result information matching the color encoding information, and sending the obtained search result information to the user terminal device.

Another aspect of the present disclosure is directed to a user device for a color search. The user device may comprise a sending apparatus that sends a color search request and corresponding color encoding information to a network device, and a receiving apparatus that receives search result information that matches the color encoding information and that is returned by the network device based on the color search request.

Another aspect of the present disclosure is directed to a network device for a color search. The network device may comprise an acquiring apparatus that acquires, from a user terminal device, a color search request and the corresponding color encoding information, a querying apparatus that queries according to the acquired color encoding information to obtain search result information matching the color encoding information, and a sending apparatus that sends the obtained search result information to the user terminal device.

Another aspect of the present disclosure is directed to a non-transitory computer readable medium storing one or more programs, the one or more programs comprising instructions which, when executed by a processor of a computer system including a user terminal device, cause the computer system to perform a method. The method may comprise sending a color search request and corresponding color encoding information to a network device, and receiving search result information that matches the color encoding information and that is returned by the network device based on the color search request.

Additional features and advantages of the present disclosure will be set forth in part in the following detailed description, and in part will be obvious from the description, or may be learned by practice of the present disclosure. The features and advantages of the present disclosure will be realized and attained by means of the elements and combinations particularly pointed out in the appended claims.

It is to be understood that the foregoing general description and the following detailed description are exemplary and explanatory only, and are not restrictive of the invention, as claimed.

### BRIEF DESCRIPTION OF THE DRAWINGS

The accompanying drawings, which constitute a part of this specification, illustrate several embodiments and, together with the description, serve to explain the disclosed principles.

FIG. 1 is a block diagram illustrating a system for a color search, consistent with embodiments of the present application.

FIG. 2 is a block diagram illustrating a sending apparatus 11, consistent with embodiments of the present application.

FIG. 3 is a block diagram illustrating a system for a color search, consistent with embodiments of the present application.

FIG. 4 is a flow diagram illustrating a method for a color search, consistent with embodiments of the present application.

FIG. 5 is a flow diagram illustrating a method for a color search, consistent with embodiments of the present application.

FIG. 6 is a flow diagram illustrating a method for a color search, consistent with embodiments of the present application.

FIG. 7 is a graphical illustration of an interface of a device for a color search, consistent with embodiments of the present application.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments consistent with the present invention do not represent all implementations consistent with the invention. Instead, they are merely examples of systems and methods consistent with aspects related to the invention as recited in the appended claims.

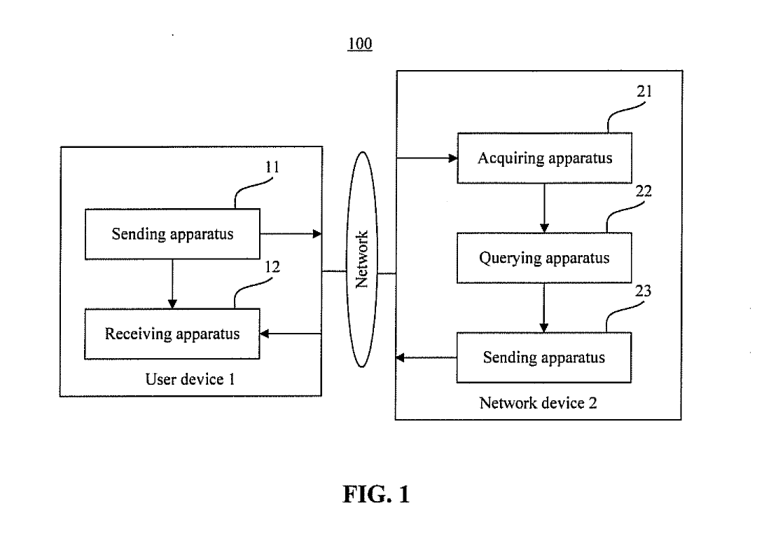

FIG. 1 is a block diagram illustrating a system 100 for a color search, consistent with embodiments of the present application. The system 100 may include a user device 1 and a network device 2. The user device 1 may include a sending apparatus 11 and a receiving apparatus 12; and the network device 2 may include an acquiring apparatus 21, a querying apparatus 22, and a sending apparatus 23.

In some embodiments, the sending apparatus 11 may send a color search request and corresponding color encoding information to the network device 2. The acquiring apparatus 21 may acquire the color search request and the corresponding color encoding information sent by the user device 1. The querying apparatus 22 may query according to the color encoding information to acquire search result information matching the color encoding information. The sending apparatus 23 may send the search result information to the user device 1. At the same time, the receiving apparatus 12 may receive the search result information, which matches the color encoding information and is based on the color search request, from the network device 2.

In some embodiments, the sending apparatus 11 may send the color search request and the corresponding color encoding information to the network device 1. The user device 1 may include various smart terminals, such as smart phones and personal computers. The network device 2 may include various cloud servers. The color encoding information may be determined based on a color encoding standard. For example, the color encoding standard may include hexadecimal color codes, a Munsell color system model, or various current or future color models for color recognition, e.g., a Hue Saturation Value (HSV) color model, a Hue Saturation Brightness (HSB) color model. The color encoding standards may define a large number of visible color types, and even some color encoding standards. For example, the hexadecimal color codes may include most known color types. The color search request may be sent by a user through various methods. For example, the user may directly select a desired color from color pattern information presented in the user device 1, instead of using the conventional method of inputting known name information of the color as a search query. The color pattern information may be selected from a color selection region based on a color model presented in the user device 1, from a candidate color display region presented in the user device 1, or any region presented on the user device 1 and selectable based on a color acquiring module. Moreover, the color search request may further include target color information selected and/or input by the user through an external device, such as a digital panel and a color picker. When the color search request includes corresponding color encoding information, that is, when the user selects or inputs determined target color information, the user device 1 may determine matching color encoding information with the target color information based on a preset color encoding standard, and then, send the color search request and the corresponding color encoding information to the network device 2. Moreover, the color search request may be sent to the network device independently or together with another search condition of the search object. For example, the user inputs, in a text input box of the user device 1, a type of the object to search, and at the same time, selects color pattern information of a certain color, before submitting the type of the object and the color pattern information at the same time.

Then, the acquiring apparatus 21 of the network device 2 may acquire the color search request and the corresponding color encoding information sent by the user device 1. Further, the querying apparatus 22 may query according to the color encoding information to obtain search result information matching the color encoding information. In some embodiments, the preset color encoding standard corresponding to the color encoding information in the user device 1 may be the same as or different from color encoding standard corresponding to object color encoding information configured for storing and managing the corresponding search object in the network device 2. If the color encoding standards are the same, the color encoding information may be acquired directly through the acquiring apparatus 21, and through the querying apparatus 22, the search object with the same color encoding information and meeting other search conditions may be found in the network device. If the two color encoding standards are different, the acquired color encoding information may be converted into corresponding object color encoding information based on a conversion relationship between the color encoding standards. For example, the color search request sent by the user device 1 corresponds to color encoding information defined by the Munsell color system model, and a color selection requirement of the user may be met since color pattern information corresponding to the Munsell color system model is abundant and visual. Since the hexadecimal color codes can label almost all known color types and is more commonly used internationally, the network device 2 may adopt the hexadecimal color codes as the object color encoding standard. At this moment, when the querying apparatus 22 performs the query operation, the color encoding information defined by the Munsell color system model corresponding to the color search request may need to be converted into a hexadecimal color code corresponding to the color before a search operation is performed in the network device 2 based on the hexadecimal color code.

Then, the sending apparatus 23 of the network device 2 may send the search result information to the user device 1. At the same time, the receiving apparatus 12 of the user device 1 may receive search result information that matches the color encoding information and returned by the network device 2 based on the color search request. The search result information sent by the network device 2 to the user device 1 may be all identified objects from the search, or a part of the objects preferably selected according to the requirement. Moreover, the network device 2 may further provide preferred arrangement information of the search result information for the user device 1 based on a historical search frequency or a probability of the objects being selected.

In some embodiments, the user device 1 may send the color search request and the corresponding color encoding information to the network device 2 to obtain the search result information matching the color encoding information. The search request sent by the user device 1 may include standard color encoding information to be used as the search condition so that the color requested by the user device accurately matches the acquired search result information, and information discrepancies caused by the color name based search may be corrected. Since various types of color encoding information may cover most colors, and some types of color encoding information settings may cover most recognizable colors, more color selection options can thus be provided to users to enrich their product experience.

Correspondingly, the network device 2 may query for matching search result information based on the color search request and the corresponding color encoding information sent by the user device 1, and return the search result information to the user device 1 to satisfy the color search request of the user. To allow convenient collection and management of the color information of the search object, the network device 2 may select universal color encoding information to edit search object information.

In some embodiments, the network device 2 may further include an object color encoding information acquiring apparatus (not shown in figures) that acquires object color encoding information corresponding to the search object information. The querying apparatus 22 may compare the color encoding information with the object color encoding information, and determine, from one or more search objects, the search result information matching the color encoding information.

In some embodiments, the network device 2 may acquire the object color encoding information of the search object from a device providing the search object, and the color encoding standard corresponding to the object color encoding information may be the same as or different from that sent by the user device 1. There may be various methods of acquiring the object color encoding information.

Far example, the providing device may directly send name information of the object color, and then the network device 2 may determine object color encoding information matching the name information. For example, the name information is red, and a matching hexadecimal color code corresponding to red may be determined. As another example, multiple pieces of color pattern information for selection are displayed at the same time in a device, and based on selection information of a user of the device, the object color encoding information of the search object may be determined. For still another example, a device may provide the picture information of a search object, and the network device 2 may parse the color pattern information of the search object in the picture information and determine the object color encoding information. Here, a requirement of uploaded pictures may be determined, e.g., the picture has to contain a single product object and a single color; or a server may automatically select a recognition region in the picture, e.g., the server may select display content in a determined range in the central region of the picture to perform color recognition.

Persons skilled in the art should understand that the acquiring method of the object color encoding information is an example, and other current or future methods of acquiring the object color encoding information shall fall within the protection scope of the present application, which may be incorporated herein by reference.

Then, the querying apparatus 22 may compare the color encoding information with the object color encoding information, and determine, from one or more search objects, the search result information matching the color encoding information. The matching search result information that will be returned to the corresponding user device 1 may be determined from multiple search objects in combination with other search conditions.

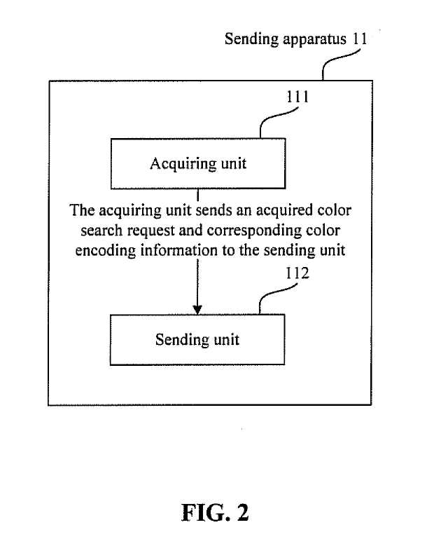

FIG. 2 is a block diagram of a sending apparatus 11, according to an exemplary embodiment of the present disclosure. The sending apparatus 11 may include an acquiring unit 111 and a sending unit 112.

In some embodiments, the acquiring unit 111 may acquire a color search request and corresponding color encoding information; and the sending unit 112 may send the color search request and the corresponding color encoding information to a network device 2.

In some embodiments, the acquiring unit 111 may acquire the color search request and the corresponding color encoding information. There may be many methods for the user device to acquire the color search request and the corresponding color encoding information. For example, the user may directly select a desired color from color pattern information presented in the user device 1 as the search request and match that with corresponding color encoding information. The search request may not be limited to conventional methods of inputting known name information of the color to search. The presented color pattern information may be selected from a color selection region based on a color model presented in the user device 1, or a candidate color display region presented in the user device 1. It may also be selected from any region presented on the user device 1, and may be selected based on the color acquiring module. As another example, the color search request may include selected target color information input by the user through a corresponding external device, such as a digital panel and a color picker, and corresponding color encoding information may be determined based on the target color information. As another example, the color search request may further include a search key word corresponding to the target color input or selected by the user, and the search key word may correspond to the corresponding color encoding information. As another example, the color search request may further include color encoding information of the target color directly input by the user.

People skilled in the art should understand that the acquiring method of the color search request and the corresponding color encoding information are examples, other current or future methods of acquiring the color search request and the corresponding color encoding information shall fall within the protection scope of the present application, which may be incorporated herein by reference.

Then, the sending unit 112 may send the color search request and the color encoding information to the network device 2. The color search request may be sent to the network device independently or together with another search condition of the search object. For example, the user inputs, in a text input box of the user device 1, a type of the object to search, and selects the color pattern information of a certain color, before submitting the type and the color pattern information at the same time. Moreover, the color search request may be sent out when the current search object corresponding to a prior search condition is determined. For example, the prior search condition may be the name of the search object, and the corresponding search result information may be returned by the corresponding network device 2. Therefore, the user may submit the color search request and the color encoding information again based on the search result information, and may send them to the network device 2. Subsequently, the network device 2 may return new search result information that meets the object name and matches the color encoding information.

In some embodiments, the user device 1 may acquire the color search request and the corresponding color encoding information through various methods, so that the user can select the most appropriate requesting method based on actual requirements of the user. For example, if a user does not know the name of the color, the user may select directly from multiple pieces of given color pattern information.

In some embodiments, the acquiring unit 111 may acquire a color search request submitted by a user, where the color search request includes a search key word input by the user; and determine the color encoding information corresponding to the search key word.

In some embodiments, the user device may acquire or set in advance the search key word corresponding to the color encoding information, and one search key word may correspond to one or more pieces of color encoding information. The search key word may be associated with the corresponding color encoding information. That is, the search key word may be associated with a color corresponding to the color encoding information by general knowledge. For example, when the search key word is “cool,” it may be set that color encoding information of colors such as blue and green matches with the search key word. Therefore, when the user inputs the key word “cool,” or a synonym of the key word, preset color encoding information corresponding to the key word may be determined automatically based on the color search request.

The application of the search key word may describe color information from various sensory experiences of colors to flexibly match color encoding information that meets the search objective for the user, and to ultimately determine search result information that meets the expectation of the user.

In some embodiments, the acquiring unit 111 may acquire a color search request submitted by a user through a corresponding external device, and determine the corresponding color encoding information based on the color search request.

In some embodiments, the external device may include, but is not limited to, a color picker, a digital panel, a writing pad, a scanning apparatus, and other electronic devices. For example, the color picker may be placed on any object of which a color is to be selected. By pressing a scan button of the color picker, a color sensor in the picker may sense the color, and the sensed color may be transmitted to the user device. Or, a three-primary colors ink pipe of the color picker may obtain a matching color by mixing the primary colors and drawing the color on a medium such as a piece of paper. The user device 1 may acquire the corresponding color search request through a scanning apparatus or a scanning function thereof. As another example, a color may be selected on a color picking panel of the digital panel, and then the selected color information may be directly sent to the user device 1 as the color search request. Then, the user device 1 may determine corresponding color encoding information based on the color search request.

People skilled in the art should understand that the color search request submitted by the user through the corresponding external device is an example, other current or future methods of the color search request submitted by the user through the corresponding external device shall fall within the protection scope of the present application, which may be incorporated herein by reference.

In some embodiments, the acquiring unit 111 may acquire a color search request submitted by a user, where the color search request includes color pattern information selected by the user, and determine the color encoding information corresponding to the color pattern information.

In some embodiments, the color pattern information may be selected from a color selection region based on a color model presented in the user device 1, from a candidate color display region presented in the user device 1, or from any region presented on the user device 1. It may also be selected based on the color acquiring module. The color pattern information may be different from the color name information in a text description. In the user device, a large number of or most of the visualized color pattern options may be provided. The user may select the target color based on the real pattern information of the viewed color, without a conversion of text name, which is convenient for the user to operate. Meanwhile, the selectable color types provided by the user device 1 based on the color model may be abundant such that they may fully meet the requirement of the user.

In one embodiment with reference to FIG. 2, the color pattern information selected by the user may be selected from at least one of: a color selection region based on the color model presented in the user device 1, a candidate color display region presented in the user device 1, or any region present in the user device 1, where the user selects the color pattern information from any region through a color acquiring module in a corresponding search application.

In some embodiments, the color pattern information may be selected from the color selection region based on the color model presented in the user device 1. The color selection region may be configured on the user device 1 to collectively display multiple colors to be selected, and the corresponding color selection region may be determined based on a certain color model. For example, color panels corresponding to hexadecimal color codes may be used as the configured color selection region. As another example, the corresponding color selection region may be determined by using the Munsell color system model as a standard.

In some embodiments, the color pattern information may also be selected from the candidate color selection region presented in the user device 1. The colors displayed in the candidate color display region may correspond to color types being frequently searched or selected in a corresponding application by the user device 1 using recent statistics. Further, the colors may be based on frequently searched or selected color types from the search history of search objects that are the same as or similar to the current search object in the user device 1. Further, the colors may be frequently searched and selected color types, which are in the search history, are the same as or similar to the current search object of the user device 1, and are statistically determined by the current application. For example, the network device 2 or any other third-party device may analyze or provide the statistical determination, and at this time, the history search information may not be limited to that from the current user device 1, and may further include history search information from other user devices.

In some embodiments, the color pattern information may further be selected from any region presented in the user device 1. The user may select the color pattern information from any region through a color acquiring module in a corresponding search application. For example, in addition to the color selection region based on the color model or the candidate color display region, the user device may have other display regions, and contents of the other display regions may include corresponding color information. The color acquiring module may include a color selection function in the corresponding search application. For example, the color acquiring module may appear as a color selection function icon on a display interface, the user can select the color selection function icon, and then select any color on the display interface based on the selection function as the selected color pattern information.

In some embodiments, the user device 1 may further include a candidate color determining apparatus (not shown), and the candidate color determining apparatus may determine a candidate color in the candidate color display region according to the current search object corresponding to the color search request.

In some embodiments, the color search may be combined with another search condition, such as an object name search. For example, a first search may be performed based on another search condition, such as a name of the search object. Then, a second search, e.g., the color search, may be performed on search result information corresponding to the first search. In this case, after the current search object information is determined, the user device may flexibly determine a candidate color in the candidate color display region based on the current search object, and different search objects may match different candidate colors. For example, if the current search object is a mobile phone, common colors such as black, white, gray, golden, red, and blue may be displayed in the candidate color display region, and the common colors may come from selection histories of users by statistics, or from frequently appearing colors corresponding to this type of product. As another example, if the current object is a one-piece dress, colors displayed in the candidate color display region may be selected by users frequently in a recent time, since the dress has many color types, and user selections may indirectly reflect current trends. The colors displayed in the candidate color display region may have a high search frequency by the user of the current user device 1 recently through a current search application, and the color selection of the current user may reflect preferences of the user on colors.

In some embodiments, candidate colors in the candidate color display region may be determined flexibly according to the current search object corresponding to the color search request, thereby improving the user experiences.

In some embodiments, the color selection region based on the color model may include any one of the following: a hue and chroma presentation region and a brightness presentation region based on the Munsell color system model, where hue and chroma information in the hue and chroma presentation region corresponds one-to-one to brightness information in the brightness presentation region; a spherical color presentation region determined by hue, brightness, and chroma factors based on the Munsell color system model, where a presentation view angle in the spherical color presentation region changes along with user operations.

In some embodiments, the Munsell color system model is a sphere-like three-dimensional space model. A color strip may be provided at the equator of the sphere and have various hues distributed sequentially. Different chroma levels may extend from the axial horizontal direction of the sphere, from neutral gray to complete saturation. The brightness of the axis of the sphere may be neutral gray, the north pole may be white, and the south pole may be black. The three factors of hue, chroma, and brightness may uniquely determine a color, and therefore, variations of the three factors may define colors comprehensively.

In some embodiments, the Munsell color system model may be flattened. That is, the hue and chroma presentation region and the brightness presentation region of the Munsell color system model may be transformed to serve as the color selection region. In one embodiment, the hue and chroma presentation region may be a section of the sphere corresponding to the Munsell color system model under a determined brightness. In one embodiment, the region may be a circular region, overlapping with or parallel to an equator section. In one embodiment, the brightness presentation region may be an axial region sequentially embodying brightness information. In one embodiment, the brightness presentation region, e.g., the axial region, may correspond to a selection position icon. When certain brightness in the axial region is determined, the hue and chroma presentation region, e.g., the circular region, may be determined uniquely. Thus, the hue and chroma information in the hue and chroma presentation region may have one-to-one correspondence to the brightness information in the brightness presentation region.

In some embodiments, a spherical color presentation region may be determined by hue, brightness, and chroma factors based on the Munsell color system model, where a presentation view angle in the spherical color presentation region changes along with user operations. Each basic unit on the sphere may correspond to a selectable color, and the user can determine color pattern information based on a selection of the basic unit. In one embodiment, the user may select specific color pattern information on a side facing the user by using a gesture operation, such as sliding upward, downward, leftward or rightward. The user may further adjust the size and amount of the viewed color pattern information by zooming in or zooming out.

Persons skilled in the art should understand that the two color selection regions based on the color model are merely examples. Current or future color selection regions based on the color model shall fall within the protection scope of the present application, which may be incorporated herein by reference.

Persons skilled in the art should also understand that the two color selection regions based on the Munsell color system model are merely examples. Current or future color selection regions based on the Munsell color system model shall fall within the protection scope of the present application, which may be incorporated herein by reference.

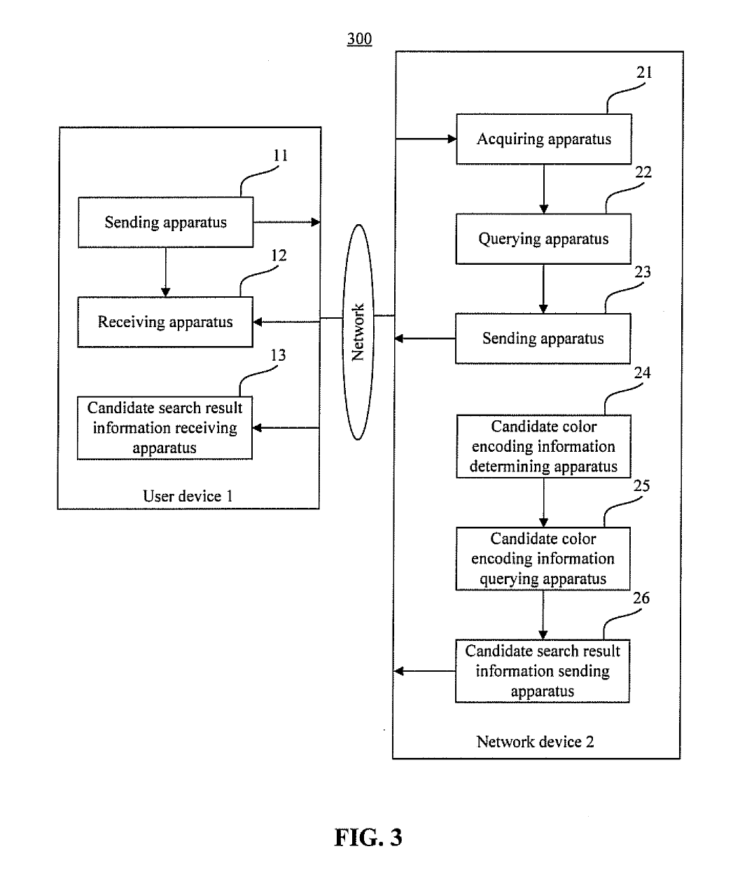

FIG. 3 is a block diagram illustrating a system 300 for a color search, according to another exemplary embodiment. The system 300 may include a user device 1 and a network device 2. Similar to the components described above with reference to FIG. 1, the user device 1 may include a sending apparatus 11 and a receiving apparatus 12. The network device 2 may include an acquiring apparatus 21, a querying apparatus 22, and a sending apparatus 23. The user device 1 may further include a candidate search result information receiving apparatus 13. The network device 2 may further include a candidate color encoding information determining apparatus 24, a candidate color encoding information querying apparatus 25, and a candidate search result information sending apparatus 26. Here, the candidate search result information receiving apparatus 13 may work together with the sending apparatus 11 and the receiving apparatus 12, or may be implemented independently. The candidate color encoding information determining apparatus 24, the candidate color encoding information querying apparatus 25, and the candidate search result information sending apparatus 26 may work together with the acquiring apparatus 21, the querying apparatus 22, and the sending apparatus 23, or may be implemented independently.

In some embodiments, the candidate color encoding information determining apparatus 24 may determine candidate color encoding information corresponding to the color encoding information. Then, the candidate color encoding information querying apparatus 25 may query according to the candidate color encoding information to acquire candidate search result information matching the candidate color encoding information. Then, the candidate search result information sending apparatus 26 may send the candidate search result information to the user device, and the candidate search result information receiving apparatus 13 of the user device 1 may receive the candidate search result information that matches the candidate color encoding information corresponding to the color encoding information and that is returned by the network device based on the color search request.

In some embodiments, the candidate color encoding information determining apparatus 24 may first determine candidate color encoding information corresponding to the color encoding information. The network device may preset the candidate color encoding information corresponding to the color encoding information, and one or more pieces of candidate color encoding information may be matched with the color encoding information. Using the Munsell color system model as an example, in one embodiment, candidate color encoding information corresponding to one or more candidate colors with similar brightness or chroma may be determined in a hue range corresponding to the color encoding information. Or, when required, candidate color encoding information corresponding to one or more candidate colors, having different hues but the same or similar brightness or chroma, may be selected.

Then, the candidate color encoding information querying apparatus 25 may query according to the candidate color encoding information to obtain candidate search result information matching the candidate color encoding information. If there are multiple pieces of candidate color encoding information, a corresponding search query may be performed on each candidate color encoding information sequentially.

Then, the candidate search result information sending apparatus 26 may send the candidate search result information to the user device, and the candidate search result information receiving apparatus 13 of the user device 1 may receive the candidate search result information that matches the candidate color encoding information corresponding to the color encoding information and that is returned by the network device based on the color search request. If there are multiple pieces of candidate color encoding information, priorities may be determined according to similarities between corresponding colors thereof and the color corresponding to the color encoding information. The priorities may be embodied in an arrangement order of the search result information presented by the user device 1.

The network device 2 may further determine corresponding candidate search result information according to the candidate color encoding information corresponding to the color encoding information, and provide the candidate search result information to the corresponding user device 1. A range, in which the user can actually select search results when the requirements cannot be met by the color encoding information search, may be expanded through the determination of the candidate search result information.

In one embodiment, the candidate color encoding information determining apparatus 24 may determine candidate color encoding information corresponding to the color encoding information when a candidate triggering condition is met. The candidate triggering condition may include, for example, at least one of the following: the search result information is not found; the number of certain pieces of the search result information is less than a preset threshold; and a candidate color request corresponding to the color search request is received.

In some embodiments, the candidate triggering condition may include that the search result information is not found. That is, a corresponding search query is performed based on the color encoding information, and a result indicates that no corresponding search object exists. This may happen when the network device 2 has no information corresponding to a search object with the color encoding information, or when a search object has a matching color corresponding to the color encoding information but does not label the corresponding color encoding information, and therefore, cannot be found.

In some embodiments, the candidate triggering condition may include that the number of pieces of the search result information is less than a preset threshold. When there is less search result information, the range of objects selectable by the user may be greatly reduced correspondingly, and therefore, at this time, candidate color encoding information may be determined for the user to expand the selection range. The preset threshold may refer to object number information of a stream browsing search result during each query, and in one embodiment, appropriate preset thresholds may be configured flexibly for different users according to their browsing habits.

In some embodiments, the candidate triggering condition may include that a candidate color request corresponding to the color search request is received. When the above two conditions are met, the user device 1 may remind the corresponding user to send the candidate color request. Further, even if the above two cases do not occur, the user may automatically perform a search of the candidate color based on the determined candidate color encoding information. For example, candidate color options may always be displayed on an interface of the user device 1 for the user to select any time to acquire the candidate search result information.

Persons skilled in the art should understand that the three candidate triggering conditions are merely examples, current and future candidate triggering conditions shall fall within the protection scope of the present application, which may be incorporated herein by reference.

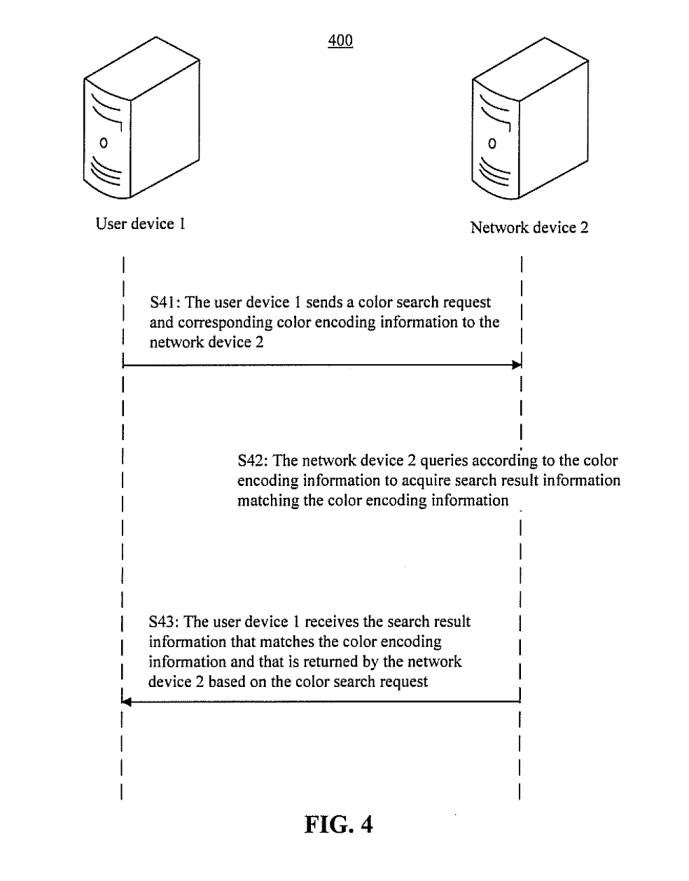

FIG. 4 is a flow diagram illustrating a method 400 for a color search, according to an exemplary embodiment. Method 400 may be performed by a computer system 100 or 300 described above. The computer system may comprise a processor and a non-transitory computer-readable storage medium storing instructions that, when executed by the processor, perform the steps described below. The method 400 includes a step S41, a step S42, and a step S43.

In step S41, a user device 1 may send a color search request and corresponding color encoding information to a network device 2. In step S42, the network device 2 may query according to the color encoding information to acquire search result information matching the color encoding information. Then, in step S43, the user device 1 may receive the search result information that matches the color encoding information and that is returned by the network device 2 based on the color search request.

In some embodiments, in step S41, the user device 1 may send the color search request and the corresponding color encoding information to the network device 1. The user device 1 may include various smart terminals, such as smart phones and various personal computers, and the network device 2 may include various cloud servers. The color encoding information may be determined based on a certain color encoding standard. In one embodiment, the color encoding standard may include hexadecimal color codes and a Munsell color system model. It may also include any current or future color model for color recognition and labelling. For example, the color model may include: a Hue, Saturation, Value (HSV) color model, a Hue, Saturation, Brightness (HSB) color model, and the like. The various color encoding standards may define a large number of visible color types, and even some color encoding standards. For example, the hexadecimal color codes almost can include all known color types. The color search request may be sent by the user, and in some embodiments, there may be many methods for the user to send the color search request. For example, the user may directly select a desirable color from numerous color pattern information presented in the user device 1, instead of being limited by the conventional method of inputting known name information of the color us a search request. The color pattern information presented may be selected from a color selection region based on a color model presented in the user device 1, a candidate color display region presented in the user device 1, or any region presented on the user device 1 and selectable based on the color acquiring module. Moreover, the color search request may further include target color information input by the user through a corresponding external device, such as a digital panel and a color picker. When the color search request includes corresponding color encoding information, that is, when the user selects or inputs determined target color information, the user device 1 may determine matching color encoding information corresponding to the target color information based on a preset color encoding standard, and then, send the color search request and the corresponding color encoding information to the network device 1. Moreover, the color search request may be sent to the network device independently or together with another search condition of the search object. For example, the user inputs, in a text input box of the user device 1, a type of the object to search, and at the same time, selects color pattern information of a certain color, thereby submitting the two parts of information at the same time.

Further, in step S42, the network device 2 may query according to the color encoding information to obtain search result information matching the color encoding information. In some embodiments, the preset color encoding standard corresponding to the color encoding information in the user device 1 may be the same as or different from color encoding standard corresponding to object color encoding information configured for storing and managing the search object in the network device 2. If the color encoding standards are the same, the network device 2 may directly query the search object having the same color encoding information and meeting the another search condition. If the two color encoding standards are different, the color encoding information may be acquired first, and be converted into corresponding object color encoding information based on a conversion relationship between the color encoding standards. For example, the color search request sent by the user device 1 corresponds to color encoding information defined by the Munsell color system model, and a color selection requirement of the user may be met since color pattern information corresponding to the Munsell color system model is abundant and visual. Since the hexadecimal color codes can label almost all known color types comprehensively and are more internationally used, the network device 2 may adopt the hexadecimal color codes as the object color encoding standard. When the inquiry operation is performed, the color encoding information defined by the Munsell color system model corresponding to the color search request may be converted into a hexadecimal color code corresponding to the color, and therefore, a search operation may be performed in the network device 2 based on the hexadecimal color code.

Then, in step S43, the user device 1 may receive the search result information that matches the color encoding information and that is returned by the network device 2 based on the color search request. The search result information sent by the network device 2 to the user device 1 may be all objects obtained from the search, or a part of the objects selected from the search according to the requirement. Moreover, the network device 2 may further provide preferred arrangement information of the search result information for the user device 1 based on a history search frequency or a selection probability of the search objects.

In some embodiments, the user device 1 of the present application may send the color search request and the corresponding color encoding information to the corresponding network device 2, thereby obtaining the search result information matching the color encoding information. The search request sent by the user device 1 may include standard color encoding information as the search condition, thereby ensuring that the color requested by the user device accurately matches the acquired search result information, and that discrepancies caused by the search based on a color name is compensated. Since various types of color encoding information may cover most colors, and some types of color encoding information settings may almost cover all recognizable colors, more color selection options may be provided for the users to enrich their experience.

Correspondingly, the network device 2 may query matching search result information based on the color search request and the corresponding color encoding information sent by the user device 1, and may return the search result information to the user device 1 to perform the color search request of the user. In one embodiment, network device 2 may select universal color encoding information to edit search object information. This facilitates the convenient collection and management of the color information of the search object.

In one embodiment, method 400 may further include a step S47 (not shown). In step S47, the network device 2 may acquire object color encoding information corresponding to the search object information, and in step S42, the network device 2 may compare the color encoding information with the object color encoding information to determine, from one or more search objects, the search result information matching the color encoding information.

In some embodiments, the network device 2 may acquire the object color encoding information of the search object from a providing device of the search object, and the color encoding standard corresponding to the object color encoding information may be the same as or different from the color encoding standard corresponding to the color encoding information sent by the user device 1. There may be various ways of acquiring the object color encoding information.

For example, the providing device may directly send the name information of the object color. The network device 2 may then match corresponding object color encoding information with the name information. For example, if the name information is red, a hexadecimal color code corresponding to red may be matched. As another example, multiple pieces of search color pattern information may be displayed at the same time in the providing device, and based on selection information of the user corresponding to the providing device, the object color encoding information of the search object may be determined. As another example, the providing device may further provide image information of the search object, and the network device 2 may parse the color pattern information of the search object in the image information to determine the object color encoding information. In one embodiment, a requirement for uploaded pictures may be determined in advance. An exemplary requirement may include that the picture must contain a single product object and a single color. Also, a server may automatically select a recognition region in the picture, e.g., the server may select display content in a determined range in the central region of the picture to perform corresponding color recognition.

Persons skilled in the art should understand that the acquiring method of the object color encoding information is merely an example, current or future methods of acquiring the object color encoding information shall fall within the protection scope of the present application, which may be incorporated herein by reference.

Then, in step S42, the network device 2 may compare the color encoding information with the object color encoding information, and determine, from one or more search objects, the search result information matching the color encoding information. The search result information that matches and returned to the corresponding user device 1 may be determined from multiple search objects in combination with other search conditions.

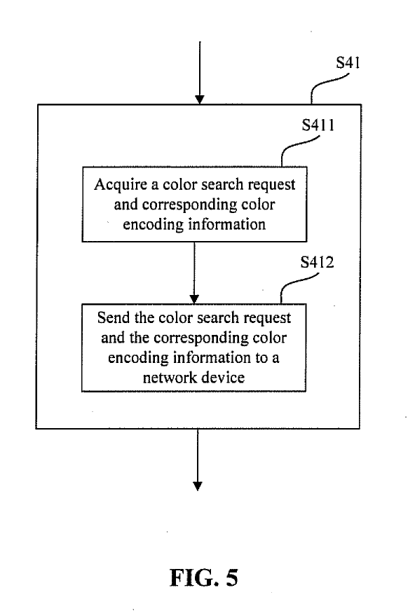

FIG. 5 is a flow diagram illustrating a method for a color search, according to an exemplary embodiment. The step S41 may include a step S411 and a step S412.

In some embodiments, in step S411, the user device 1 may acquire a color search request and corresponding color encoding information; and in step S412, the user device 1 may send the color search request and the corresponding color encoding information to a network device 2.

In some embodiments, in step S411, the user device 1 may acquire the color search request and the corresponding color encoding information. There are many ways for the user device to acquire the color search request and the corresponding color encoding information. For example, the user may directly select a desired color from color pattern information presented in the user device 1, as the search request matching corresponding color encoding information. Without being limited to the conventional method of inputting known name information of the color to serve as the search request, the presented color pattern information may be selected from a color selection region based on a color model presented in the user device 1, a candidate color display region presented in the user device 1, or any region presented on the user device 1 and selectable based on the color acquiring module. As another example, the color search request may include selected target color information input by the user through a corresponding external device, such as a digital panel and a color picker, and corresponding color encoding information may be determined based on the target color information. As another example, the color search request may further include a search key word corresponding to the target color input or selected by the user, and the search key word may correspond to the corresponding color encoding information. As another example, the color search request may further include color encoding information of the target color directly input by the user.

Persons skilled in the art should understand that the acquiring method of the color search request and the corresponding color encoding information is merely an example, current or future methods of acquiring the color search request and the corresponding color encoding information shall fall within the protection scope of the present application, which may be incorporated herein by reference.

In step S412, the user device 1 may send the color search request and the corresponding color encoding information to the network device 2. The color search request may be sent to the network device independently or together with another search condition of the search object. For example, the user may input, in a text input box of the user device 1, a type of the object to search, and at the same time, select color pattern information of a certain color, thereby submitting two parts of information at the same time. Moreover, the color search request may be sent out when the current search object corresponding to a prior search condition is determined. For example, the prior search condition may be the name of the search object, and corresponding search result information may be returned by the corresponding network device 2. Therefore, the user may submit the color search request and the color encoding information again based on the search result information, and send them to the network device 2. Subsequently, the network device 2 may return new search result information that satisfies the object name and matches the color encoding information.

In some embodiments, the user device 1 may acquire the color search request and the corresponding color encoding information in many ways, so that the user can select the most appropriate requesting method based on actual requirements of the user. For example, if a user does not know the name of the color, the user may select directly from multiple pieces of color pattern information.

In one embodiment, in step S411, the user device 1 may acquire a color search request submitted by a user, where the color search request includes a search key word input by the user; and may determine the color encoding information corresponding to the search key word.

In some embodiments, the user device may acquire or configure in advance the search key word corresponding to the color encoding information, and one search key word may correspond to one or more color encoding information. In one embodiment, the search key word may have a certain associative relationship with the corresponding color encoding information, that is, the search key word may be associated to the color corresponding to the color encoding information using general knowledge. For example, when the search key word is “cool,” it may be configured that color encoding information of colors such as blue and green matches the search key word. Therefore, when the user inputs the key word “cool” or a synonym thereof, preset color encoding information corresponding to the key word may be determined automatically based on the color search request.

The application of the search key word in this embodiment may describe color information from many sensory perspectives of colors, thereby flexibly determining matching color encoding information meeting the search objective for the user.

In one embodiment, in step S411, the user device 1 may acquire a color search request submitted by a user through the corresponding external device, and determine the corresponding color encoding information based on the color search request.

In some embodiments, the external device may include, but is not limited to, a color picker, a digital panel, a writing pad, a scanning apparatus, and other electronic devices. For example, the color picker may be placed on any object to capture its color by pressing a scan button of the color picker, a color sensor in the picker may sense the color, and the sensed color may be transmitted to the user device. Or, a three-primary colors ink pipe of the color picker may obtain the matched corresponding color by mixing the primary colors and the color is drawn on a medium such as a piece of paper, and the user device 1 may acquire the corresponding color search request with a scanning apparatus or a scanning function thereof. As another example, a color may be selected on a color picking panel of the digital panel, and then the selected color information may be directly sent to the user device 1 as the color search request. Then, the user device 1 may determine the corresponding color encoding information based on the color search request.

Persons skilled in the art should understand that the color search request submitted by the user through the corresponding external device is merely an example, other current or future methods of the color search request submitted by the user through the corresponding external device shall fall within the protection scope of the present application, which may be incorporated herein by reference.

In one embodiment, in step S411, the user device 1 may acquire a color search request submitted by a user, where the color search request includes color pattern information selected by the user; and determine the color encoding information corresponding to the color pattern information.

In some embodiments, the color pattern information may be selected from a color selection region based on a color model presented in the user device 1, from a candidate color display region presented in the user device 1, or from any region presented on the user device 1 and selectable based on the color acquiring module. The color pattern information may be different from the color name information in text description. In the user device, a large number of, or even almost all visually recognizable color pattern options may be provided, and the user can conveniently select the target color based on the as-shown color pattern information, without text name conversions. Meanwhile, abundant selectable color types provided by the user device 1 based on the color model may fully meet the requirement of the user.

In one embodiment (referring to FIG. 5), the color pattern information may be selected by the user from at least one of the following: a color selection region based on the color model presented in the user device 1; a candidate color display region presented in the user device 1; and any region present in the user device 1, where the user selects the color pattern information from any region through a color acquiring module in a corresponding search application.

In some embodiments, the color pattern information may be selected from the color selection region based on the color model presented in the user device 1. The color selection region may be set on the user device 1 to collectively display multiple colors for selection, and in one embodiment, the corresponding color selection region may be determined based on a certain color model. For example, color panels corresponding to hexadecimal color codes may directly be used as the set color selection region. As another example, the corresponding color selection region may be determined by using the Munsell color system model as a standard.

The color pattern information may also be selected from the candidate color selection region presented in the user device 1. The colors displayed in the candidate color display region may correspond to color types frequently searched or selected in a corresponding application by the user device 1 in the recent past, and the search object may be unlimited. Further, the colors may have a high search or selection frequency in the historical search information of search objects that are the same as similar to the current search object in the user device 1. Moreover, the colors may have a high search or selection frequency in the historical search information that are the same as or similar to the current search object of the user device 1 as statistically determined by the current application, for example, as analyzed or provided by the network device 2 or any other third-party device. The search history may not be limited to that from the current user device 1, and may further include that from other user devices.

The color pattern information may further be selected from any region presented in the user device 1. The user may select the color pattern information from any area through a color acquiring module in a corresponding search application. For example, in addition to the color selection region based on the color model or the candidate color display region, the user device may have other display regions, and the content of the other display regions respectively may include corresponding color information. The color acquiring module may include a color picking function configured in the corresponding search application. For example, the color acquiring module may appear as a color picker function icon on a display interface, the user may select the color picker function icon, and then may select any color on the display interface based on the picking function as the color pattern information.

In some embodiments, the method further includes a step S48 (not shown), and in step S48, the user device 1 may determine a candidate color in the candidate color display region according to the current search object corresponding to the color search request.

In some embodiments, the color search may be combined with another search condition, for example, object name search. For example, the search may be performed first based on the another search condition such as a name of the search object, and then a corresponding color search may be performed on search result information corresponding to the search. At this moment, after the current search object information is determined, the user device may flexibly determine the candidate color in the candidate color display region based on the current search object, and different search objects may match different candidate colors. For example, if the current object is a mobile phone, common colors such as black, white, gray, golden, red, and blue may be displayed in the candidate color display region, and the common colors may come from historical selection statistics of various users, or from frequently appearing colors corresponding to this type of product. As another example, if the current object is a one-piece dress, colors displayed in the candidate color display region may be colors that were frequently selected by users in the recent past. Also, if the dress has many color types, the user selections may indirectly reflect current trends. The colors displayed in the candidate color display region may further be colors frequently searched by the user of the current user device 1 in the recent past through a current search application, and the color selection of the current user may reflect the subjective preferences of the user on colors.

In some embodiments, candidate colors in the candidate color display region may be determined flexibly according to the current search object corresponding to the color search request, thereby improving the user experience.

In one embodiment, the color selection region based on the color model may include any one of the following: a hue and chroma presentation region and a brightness presentation region based on the Munsell color system model, where the hue and chroma information in the hue and chroma presentation region corresponds one-to-one to the brightness information in the brightness presentation region; a spherical color presentation region determined by hue, brightness, and chroma factors together based on the Munsell color system model, where a presentation view angle in the spherical color presentation region changes with the operation of the user.

In some embodiments, the Munsell color system model is a sphere-like three-dimensional space model. A color strip may be provided at the equator of the sphere and may have various hues distributed sequentially. Different chroma levels may extend from the axial horizontal direction of the sphere, from neutral gray to complete saturation. The brightness of the axis of the sphere may be neutral gray, the north pole may be white, and the south pole may be black. The three factors of hue, chroma, and brightness may uniquely determine a color, and therefore, variations of the three factors may define colors comprehensively.

In some embodiments, the Munsell color system model may be flattened. That is, the hue and chroma presentation region and the brightness presentation region of the Munsell color system model may be transformed to serve as the color selection region. In one embodiment, the hue and chroma presentation region may be a section of the sphere corresponding to the Munsell color system model under a determined brightness. In one embodiment, the region may be a circular region, overlapping with or parallel to an equator section. In one embodiment, the brightness presentation region may be an axial region sequentially embodying brightness information. In one embodiment, the brightness presentation region, e.g., the axial region, may correspond to a selection position icon. When certain brightness in the axial region is determined, the hue and chroma presentation region, e.g., the circular region, may be determined uniquely. Thus, the hue and chroma information in the hue and chroma presentation region may correspond one-to-one to the brightness information in the brightness presentation region.

In some embodiments, a spherical color presentation region may be determined by hue, brightness, and chroma factors based on the Munsell color system model, where a presentation view angle in the spherical color presentation region changes along with user operations. Each basic unit on the sphere may correspond to a selectable color, and the user may determine color pattern information based on selection of the basic unit. In one embodiment, the user may select specific color pattern information on a side facing the user by using a gesture operation, for example, sliding upward, downward, leftward or rightward, and may further adjust the size and amount of the viewed color pattern information by zooming in or zooming out.

Persons skilled in the art should understand that the two color selection regions based on the color model are merely examples, other current or future color selection regions based on the color model shall fall within the protection scope of the present application, which may be incorporated herein by reference.

Persons skilled in the art should understand that the two color selection regions based on the Munsell color system model are merely examples, other current or future color selection regions based on the Munsell color system model shall fall within the protection scope of the present application, which may be incorporated herein by reference.

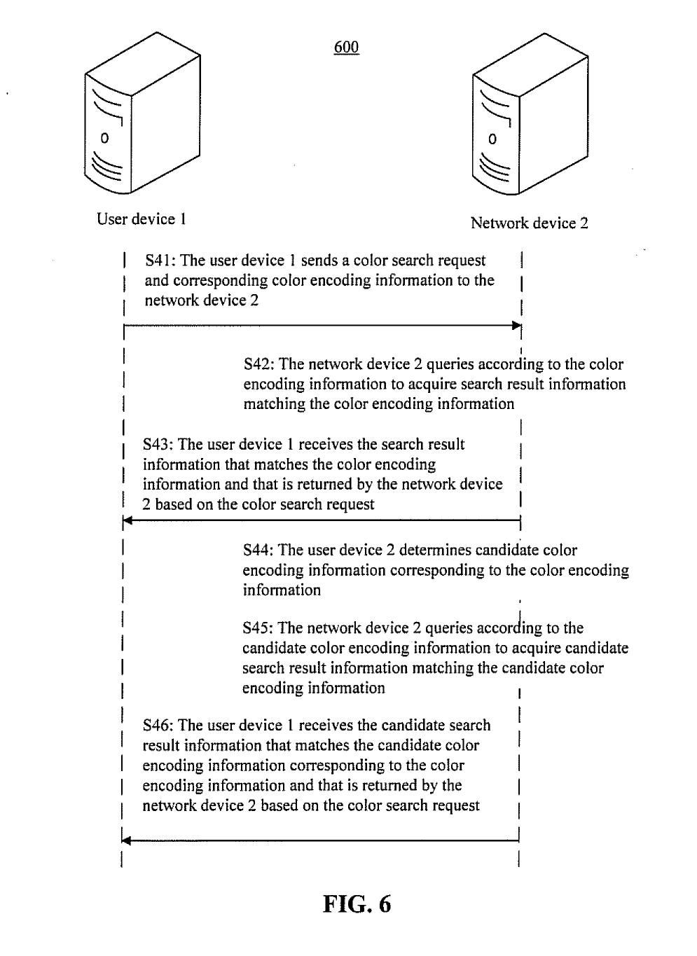

FIG. 6 is a flow diagram illustrating a method 600 for a color search, according to another exemplary embodiment. Method 600 may be performed by a computer system 100 or 300 described above. The computer system may comprise a processor and a non-transitory computer-readable storage medium storing instructions that, when executed by the processor, perform the steps described below. The method 600 may include a step S41, a step S42, a step S43, a step S44, a step S45, and a step S46. The step S41, the step S42, and the step S43 are described above with reference to FIG. 4.

In step S44, the user device 2 may determine candidate color encoding information corresponding to the color encoding information; then, in step S45, the network device 2 may query according to the candidate color encoding information to acquire candidate search result information matching the candidate color encoding information; then, in step S46, the user device 1 may receive the candidate search result information that matches the candidate color encoding information corresponding to the color encoding information and that is returned by the network device based on the color search request.

In some embodiments, in step S44, the network device 2 may determine the candidate color encoding information corresponding to the color encoding information. The network device may preset the candidate color encoding information corresponding to the color encoding information, and one or more pieces of candidate color encoding information may be matched with the color encoding information. Using the Munsell color system model as an example, in one embodiment, candidate color encoding information corresponding to one or more candidate colors may be determined correspondingly in a hue range corresponding to the color encoding information, by using a similar brightness or chroma. Or, when required, candidate color encoding information corresponding to one or more candidate colors having different hues but the same or similar brightness or chroma may be selected across the range of the same hue.

Further, in step S45, the network device 2 may query according to the candidate color encoding information to obtain candidate search result information matching the candidate color encoding information. If there are multiple pieces of candidate color encoding information, corresponding search query may be performed on each candidate color encoding information sequentially.

Then, in step S46, the user device 1 may receive the candidate search result information that matches with the candidate color encoding information corresponding to the color encoding information and that is returned by the network device based on the color search request. If there are multiple pieces of candidate color encoding information, priorities may be arranged according to similarities between corresponding colors thereof and the color corresponding to the color encoding information, and the priorities may be embodied in an arrangement order of the search result information presented by the user device 1.

The network device 2 may further determine corresponding candidate search result information according to the candidate color encoding information corresponding to the color encoding information, and provide the candidate search result information to the corresponding user device 1. A range in which the user can select search results may be expanded through the determination of the candidate search result information when the requirements cannot be met through the color encoding information search.

In one embodiment, in step S44, the network device 2 may determine candidate color encoding information corresponding to the color encoding information when a candidate triggering condition is met. The candidate triggering condition includes at least one of the following: the search result information is not queried; a number of pieces of the search result information is less than a preset threshold; and a candidate color request corresponding to the color search request is received.

In some embodiments, the candidate triggering condition may include that the search result information is not found. That is, a corresponding search query is performed based on the color encoding information, and a result indicates that no corresponding search object exists. The network device 2 may not store a search object having the color encoding information, or a search object may have a matching color corresponding to the color encoding information, but does not label the corresponding color encoding information, and therefore, cannot be found.

In some embodiments, the candidate triggering condition may include that the number of pieces of the search result information is less than a preset threshold. When there is less search result information, the range of objects selectable by the user may be correspondingly reduced, and candidate color encoding information may be determined for the user to expand the selection range. The preset threshold may refer to the object number information of a stream browsing search result during each query, and in one embodiment, appropriate preset thresholds may be configured flexibly for different users according to their browsing habits.

In some embodiments, the candidate triggering condition may include that a candidate color request corresponding to the color search request is received. When the above two conditions are met, the user device 1 may remind the corresponding user to send the candidate color request. Further, even if the above two cases do not occur, the user may automatically perform a search of the candidate color based on the determined candidate color encoding information. For example, candidate color options may always be displayed on an interface of the user device 1 for the user to select at any time to acquire the candidate search result information

Persons skilled in the art should understand that the three candidate triggering conditions are merely examples, other current or future candidate triggering conditions shall fall within the protection scope of the present application, which may be incorporated herein by reference.

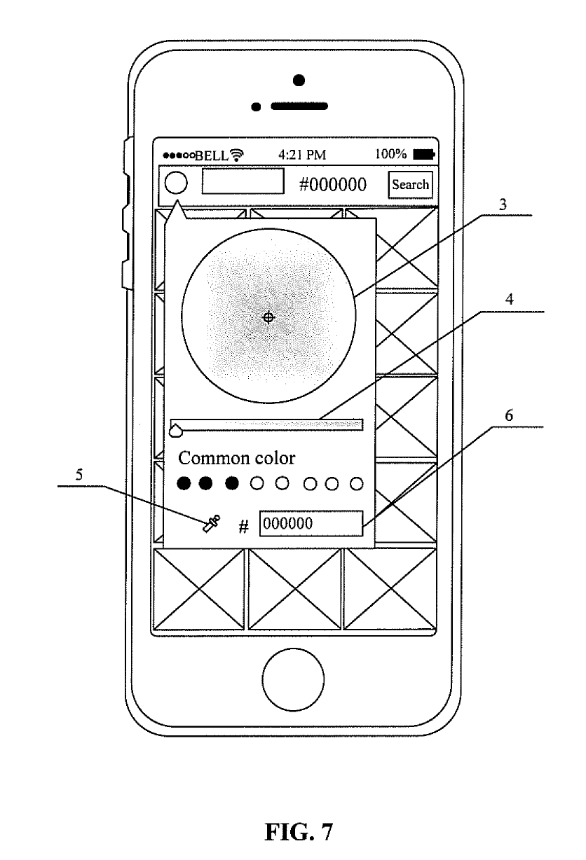

FIG. 7 is a graphical illustration of an interface of a device for a color search, according to an exemplary embodiment.

In some embodiments, the interface may display a circular hue and chroma presentation region 3 and a brightness bar presentation region 4 determined based on the Munsell color system model. A brightness may be determined by dragging the brightness bar presentation region, so that colors presented in the circular hue and chroma presentation region 3 can vary accordingly, and the user may click a target position in the hue and chroma presentation region 3 to select color pattern information corresponding to the position. Here, the candidate color display region may include a common color region shown in the drawing. The user may select a picker icon 5, thereby selecting the color pattern information in any region of the display interface. The user may input known color encoding information in a color encoding information input box 6, and the user device 1 may then send the color encoding information to a corresponding network device 2 to perform a query search. Search result information returned by the network device 2 may be acquired in the display region of the user device.

A person skilled in the art can further understand that, various exemplary logic blocks, modules, circuits, and algorithm steps described with reference to the disclosure herein may be implemented as specialized electronic hardware, computer software, or a combination of electronic hardware and computer software. For examples, the modules/units may be implemented by a processor executing software instructions stored in the computer-readable storage medium.

The flowcharts and block diagrams in the accompanying drawings show system architectures, functions, and operations of possible implementations of the system and method according to multiple embodiments of the present invention. In this regard, each block in the flowchart or block diagram may represent one module, one program segment, or a part of code, where the module, the program segment, or the part of code includes one or more executable instructions used for implementing specified logic functions. It should also be noted that, in some alternative implementations, functions marked in the blocks may also occur in a sequence different from the sequence marked in the drawing. For example, two consecutive blocks may be substantially executed in parallel, and sometimes, they may also be executed in the reverse order, depending on the functions involved. Each block in the block diagram and/or flowchart, and a combination of blocks in the block diagram and/or flowchart, may be implemented by a dedicated hardware-based system for executing corresponding functions or operations, or may be implemented by a combination of dedicated hardware and computer instructions.

As will be understood by those skilled in the art, embodiments of the present disclosure may be embodied as a method, a system or a computer program product. Accordingly, embodiments of the present disclosure may take the form of an entirely hardware embodiment, an entirely software embodiment or an embodiment combining software and hardware for allowing specialized components to perform the functions described above. Furthermore, embodiments of the present disclosure may take the form of a computer program product embodied in one or more computer-readable storage media (including but not limited to a magnetic disk memory, a CD-ROM, an optical memory, etc.) containing computer-readable program codes.

Embodiments of the present disclosure are described with reference to flow diagrams and/or block diagrams of methods, devices (systems), and computer program products according to embodiments of the present disclosure. It will be understood that each flow and/or block of the flow diagrams and/or block diagrams, and combinations of flows and/or blocks in the flow diagrams and/or block diagrams, may be implemented by computer program instructions. These computer program instructions may be provided to a processor of a computer, an embedded processor, or other programmable data processing devices to produce a machine, such that the instructions, which are executed via the processor of the computer or other programmable data processing devices, create a means for implementing the functions specified in one or more flows in the flow diagrams and/or one or more blocks in the block diagrams.

These computer program instructions may also be stored in a computer-readable memory that may direct a computer or other programmable data processing devices to function in a particular manner, such that the instructions stored in the computer-readable memory produce a manufactured product including an instruction means that implements the functions specified in one or more flows in the flow diagrams and/or one or more blocks in the block diagrams.

These computer program instructions may also be loaded onto a computer or other programmable data processing devices to cause a series of operational steps to be performed on the computer or other programmable devices to produce processing implemented by the computer, such that the instructions which are executed on the computer or other programmable devices provide steps for implementing the functions specified in one or more flows in the flow diagrams and/or one or more blocks in the block diagrams. In a typical configuration, a computer device includes one or more Central Processing Units (CPUs), an input/output interface, a network interface, and a memory. The memory may include forms of a volatile memory, a random access memory (RAM), and/or non-volatile memory and the like, such as a read-only memory (ROM) or a flash RAM in a computer-readable storage medium. The memory is an example of the computer-readable storage medium.

The computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The computer-readable medium includes non-volatile and volatile media, and removable and non-removable media, wherein information storage may be implemented with any method or technology. Information may be modules of computer-readable instructions, data structures and programs, or other data. Examples of a non-transitory computer-readable medium include but are not limited to a phase-change random access memory (PRAM), a static random access memory (SRAM), a dynamic random access memory (DRAM), other types of random access memories (RAMs), a read-only memory (ROM), an electrically erasable programmable read-only memory (EEPROM), a flash memory or other memory technologies, a compact disc read-only memory (CD-ROM), a digital versatile disc (DVD) or other optical storage, a cassette tape, tape or disk storage or other magnetic storage devices, a cache, a register, or any other non-transmission media that may be used to store information capable of being accessed by a computer device. The computer-readable storage medium is non-transitory, and does not include transitory media, such as modulated data signals and carrier waves.

The specification has described methods, apparatus, and systems for a color search. The illustrated steps are set out to explain the exemplary embodiments shown, and it should be anticipated that ongoing technological development will change the manner in which particular functions are performed. Thus, these examples are presented herein for purposes of illustration, and not limitation. For example, steps or processes disclosed herein are not limited to being performed in the order described, but may be performed in any order, and some steps may be omitted, consistent with the disclosed embodiments. Further, the boundaries of the functional building blocks have been arbitrarily defined herein for the convenience of the description. Alternative boundaries may be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

While examples and features of disclosed principles are described herein, modifications, adaptations, and other implementations are possible without departing from the spirit and scope of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

It will be appreciated that the present invention is not limited to the exact construction that has been described above and illustrated in the accompanying drawings, and that various modifications and changes may be made without departing from the scope thereof. It is intended that the scope of the invention should only be limited by the appended claims.

1. A method for a color search, implemented by a user device terminal, comprising:
sending a color search request and corresponding color encoding information to a network device; and
receiving search result information that matches the color encoding information and that is returned by the network device based on the color search request.

2. The method according to claim 1, wherein sending the color search request and the corresponding color encoding information to a network device comprises:
acquiring the color search request and the corresponding color encoding information; and
sending the color search request and the color encoding information to the network device.

3. The method according to claim 2, wherein acquiring the color search request and the corresponding color encoding information comprises:
acquiring the color search request submitted by a user, the color search request comprising a search key word input by the user; and
determining the corresponding color encoding information according to the search key word.

4. The method according to claim 2, wherein acquiring the color search request and the corresponding color encoding information comprises:
acquiring the color search request submitted by a user through a corresponding external device; and
determining the corresponding color encoding information based on the color search request.

5. The method according to claim 2, wherein acquiring the color search request and the corresponding color encoding information comprises:
acquiring the color search request submitted by a user, the color search request comprising color pattern information selected by the user; and
determining the color encoding information corresponding to the color pattern information.

6. The method according to claim 5, wherein the color pattern information is selected from at least one of:
a color selection region based on a color model presented in the user device;
a candidate color display region presented in the user device; and
any region presented in the user device, wherein the user selects the color pattern information from any region through a color acquiring module in a corresponding search application.

7. The method according to claim 6, further comprising:
determining candidate colors in the candidate color display region according to a current search object corresponding to the color search request.

8. The method according to claim 6, wherein the color selection region based on the color model comprises any one of:
a hue and chroma presentation region and a brightness presentation region based on a Munsell color system model, wherein the hue and chroma information in the hue and chroma presentation region corresponds one-to-one to brightness information in the brightness presentation region; and
a spherical color presentation region determined by hue, brightness, and chroma factors based on the Munsell color system model, wherein a presentation view angle in the spherical color presentation region changes with user operation.

9. The method according to claim 1, further comprising:
receiving candidate search result information that matches candidate color encoding information corresponding to the color encoding information and that is returned by the network device based on the color search request.

10. A method for a color search, implemented by a network device, comprising:
acquiring, from a user terminal device, a color search request and the corresponding color encoding information;
querying according to the acquired color encoding information to obtain search result information matching the color encoding information; and
sending the obtained search result information to the user terminal device.

11. The method according to claim 10, further comprising acquiring object color encoding information corresponding to search object information; and
wherein querying according to the acquired color encoding information to obtain the search result information matching the color encoding information comprises:
comparing the color encoding information with the object color encoding information, and
determining, from one or more search objects, the search result information matching the color encoding information.

12. The method according to claim 10, further comprising:
determining a candidate color encoding information corresponding to the color encoding information;
querying according to the candidate color encoding information to acquire candidate search result information matching the candidate color encoding information; and
sending the candidate search result information to the user device.

13. The method according to claim 12, wherein determining the candidate color encoding information corresponding to the color encoding information comprises determining the candidate color encoding information corresponding to the color encoding information when at least one of the following candidate triggering conditions is met:
the search result information is not found;
a number of pieces of the search result information is less than a preset threshold; and
receiving a candidate color request corresponding to the color search request.

14. A user device for a color search, comprising:
a sending apparatus that sends a color search request and corresponding color encoding information to a network device; and
a receiving apparatus that receives search result information that matches the color encoding information and that is returned by the network device based on the color search request.

15. The user device according to claim 14, wherein the sending apparatus further comprises:
an acquiring apparatus that acquires the color search request and the corresponding color encoding information; and
a sending apparatus that sends the color search request and the color encoding information to the network device.

16. The user device according to claim 15, wherein the acquiring apparatus further acquires the color search request submitted by a user, the color search request comprising a search key word input by the user; and determines the corresponding color encoding information according to the search key word.

17. The user device according to claim 15, wherein the acquiring apparatus further acquires the color search request submitted by a user through a corresponding external device; and determines the corresponding color encoding information based on the color search request.

18. The user device according to claim 15, wherein the acquiring apparatus further acquires the color search request submitted by a user, the color search request comprising color pattern information selected by the user; and determines the color encoding information corresponding to the color pattern information.

19. The user device according to claim 18, wherein the color pattern information is selected from at least one of:
a color selection region based on a color model presented in the user device;
a candidate color display region presented in the user device; and
any region presented in the user device, wherein the user selects the color pattern information from any region through a color acquiring module in a corresponding search application.

20. The user device according to claim 19, further comprising:
a candidate color determining apparatus that determines candidate colors in the candidate color display region according to a current search object corresponding to the color search request.

21. The user device according to claim 19, wherein the color selection region based on the color model comprises any one of:
a hue and chroma presentation region and a brightness presentation region based on a Munsell color system model, wherein the hue and chroma information in the hue and chroma presentation region corresponds one-to-one to brightness information in the brightness presentation region; or
a spherical color presentation region determined by hue, brightness, and chroma factors based on the Munsell color system model, wherein a presentation view angle in the spherical color presentation region changes with user operation.

22. The user device according to claim 14, further comprising:
candidate search result information receiving apparatus that receives candidate search result information that matches candidate color encoding information corresponding to the color encoding information and that is returned by the network device based on the color search request.

23. A network device for a color search, comprising:
an acquiring apparatus that acquires, from a user terminal device, a color search request and the corresponding color encoding information;
a querying apparatus that queries according to the acquired color encoding information to obtain search result information matching the color encoding information; and
a sending apparatus that sends the obtained search result information to the user terminal device.

24. The network device according to claim 23, further comprising an object color encoding information acquiring apparatus that acquires object color encoding information corresponding to search object information; and
wherein the querying apparatus further compares the color encoding information with the object color encoding information, and determines, from one or more search objects, the search result information matching the color encoding information.

25. The network device according to claim 23, further comprising:
a candidate color encoding information determination apparatus that determines a candidate color encoding information corresponding to the color encoding information;
a candidate color encoding information querying apparatus that queries according to the candidate color encoding information to acquire candidate search result information matching the candidate color encoding information; and
a candidate search result information sending apparatus that sends the candidate search result information to the user device.

26. The network device according to claim 25, wherein the candidate color encoding information determination apparatus further determines the candidate color encoding information corresponding to the color encoding information when at least one of the following candidate triggering conditions is met:
the search result information is not found;
a number of pieces of the search result information is less than a preset threshold; and
receiving a candidate color request corresponding to the color search request.

27. A non-transitory computer readable medium that stores a set of instructions that are executable by at least one processor of a computer system to cause the computer system to perform a method for color search, the method comprising:
sending a color search request and corresponding color encoding information to a network device; and
receiving search result information that matches the color encoding information and that is returned by the network device based on the color search request.

28. The non-transitory computer readable medium according to claim 27, wherein sending the color search request and the corresponding color encoding information to a network device comprises:
acquiring the color search request and the corresponding color encoding information; and
sending the color search request and the color encoding information to the network device.

29. The non-transitory computer readable medium according to claim 28, wherein acquiring the color search request and the corresponding color encoding information comprises:
acquiring the color search request submitted by a user, the color search request comprising a search key word input by the user; and
determining the corresponding color encoding information according to the search key word.

30. The non-transitory computer readable medium according to claim 28, wherein acquiring the color search request and the corresponding color encoding information comprises:
acquiring the color search request submitted by a user through a corresponding external device; and
determining the corresponding color encoding information based on the color search request.

31. The non-transitory computer readable medium according to claim 28, wherein acquiring the color search request and the corresponding color encoding information comprises:
acquiring the color search request submitted by a user, the color search request comprising color pattern information selected by the user; and
determining the color encoding information corresponding to the color pattern information.

32. The non-transitory computer readable medium according to claim 31, wherein the color pattern information is selected from at least one of:
a color selection region based on a color model presented in the user device;
a candidate color display region presented in the user device; or
any region presented in the user device, wherein the user selects the color pattern information from any region through a color acquiring module in a corresponding search application.

33. The non-transitory computer readable medium according to claim 32, the method further comprising:
determining candidate colors in the candidate color display region according to a current search object corresponding to the color search request.

34. The non-transitory computer readable medium according to claim 32, wherein the color selection region based on the color model comprises any one of:
a hue and chroma presentation region and a brightness presentation region based on a Munsell color system model, wherein hue and chroma information in the hue and chroma presentation region one-to-one corresponds to brightness information in the brightness presentation region; or
a spherical color presentation region determined by hue, brightness, and chroma factors based on the Munsell color system model, wherein a presentation view angle in the spherical color presentation region changes with user operation.

35. The non-transitory computer readable medium according to claim 27, the method further comprising:
receiving candidate search result information that matches candidate color encoding information corresponding to the color encoding information and that is returned by the network device based on the color search request.

36. A non-transitory computer readable medium that stores a set of instructions that is executable by at least one processor of a network device to cause the network device to perform a method for a color search the method comprising:
acquiring, from a user terminal device, a color search request and the corresponding color encoding information;
querying according to the acquired color encoding information to obtain search result information matching the color encoding information; and
sending the obtained search result information to the user terminal device.

37. The non-transitory computer readable medium according to claim 36, wherein the set of instructions that is executable by the at least one processor of the network device to cause the network device to further perform:
acquiring object color encoding information corresponding to search object information; and
wherein querying according to the acquired color encoding information to obtain the search result information matching the color encoding information comprises:
comparing the color encoding information with the object color encoding information, and
determining, from one or more search objects, the search result information matching the color encoding information.

38. The non-transitory computer readable medium according to claim 36, wherein the set of instructions that is executable by the at least one processor of the network device to cause the network device to further perform:
determining a candidate color encoding information corresponding to the color encoding information;
querying according to the candidate color encoding information to acquire candidate search result information matching the candidate color encoding information; and
sending the candidate search result information to the user device.

39. The non-transitory computer readable medium according to claim 38, wherein determining the candidate color encoding information corresponding to the color encoding information comprises determining the candidate color encoding information corresponding to the color encoding information when at least one of the following candidate triggering conditions is met:
the search result information is not found;
a number of pieces of the search result information is less than a preset threshold; and
receiving a candidate color request corresponding to the color search request.
